(19) United States
(12) Patent Application Publication
(10) Pub. No.: US 2010/0106299 A1
(43) Pub. Date: Apr. 29, 2010

(54) AUTOMATIC MACHINE SYSTEM AND METHOD FOR CONTROLLING COMMUNICATION THEREOF

(75) Inventor: Hideo Nagata, Kitakyushu-shi (JP)

Correspondence Address: SUGHRUE-265550, 2100 PENNSYLVANIA AVE. NW, WASHINGTON, DC, 20037-3213, US

(73) Assignee: KABUSHIKI KAISHA YASKAWA DENKI, Kitakyushu-shi (JP)

(21) Appl. No.: 11/993,227

(22) PCT Filed: May 25, 2006
(86) PCT No.: PCT/JP2006/310453

§ 371 Date: Dec. 20, 2007

(30) Foreign Application Priority Data
Jun. 20, 2005 (JP) 2005-178675

(51) Int. Cl. B25J 9/22; G05B 19/425; G05B 19/406

(52) U.S. Cl. 700/264; 700/88; 700/79; 700/83; 901/50; 901/5

(57) ABSTRACT

An automatic machine system and its communication control method not stopping the robot action even if wireless communication of a wireless portable teaching/operating unit fails. The automatic machine system comprises a mechanism unit having one or more drive mechanisms, a controller for driving/controlling the mechanism unit, and a portable teaching/operating unit for operating/teaching the mechanism unit. The controller (2) has a controller wireless communication section (24) for wireless communication with the portable teaching/operating unit (3) and a drive section (22) for driving the mechanism unit (1) according to a command signal received at the controller wireless communication section (24) from the portable teaching/operating unit (3). The portable teaching/operating unit (3) has a teaching/operating unit wireless communication section (18) for wireless communication with the controller (2), a wireless selecting switch (13) for selecting set-up or cancel of the wireless communication with the controller (2), an emergency stop switch (9) for interrupting and stopping drive energy supply to the drive section (22), and a display (8) for presenting information to the worker.

### TECHNICAL FIELD

The present invention relates to an automatic machine system which connects a controller of an automatic machine to a teaching device by means of wireless communication, as well as to a method for controlling communication of the automatic machine system.

### RELATED ART

In addition to having a control section for controlling operation of an automatic machine, a motor, and an industrial robot, a system which controls the automatic machine, the motor, and the industrial robot has a portable teaching operation section (also called a “pendant”) carried by an operator during teaching operation, or the like. There has hitherto been used a composite cable (hereinafter simply called a “cable”) which uses twisted pair line, an optical fiber, and the like, as a signal transmission path for transmission of information between the teaching operation section and the control section and which includes a line for supplying power to the teaching operation section.

By way of example, FIG. 5 shows a block diagram of a related-art robot system described in Patent Document 1. In FIG. 5, reference numeral 101 designates a robot; 102 designates a control section for controlling operation of the robot 101; 103 designates a portable teaching operation section; and 104 designates a cable for transmitting information about an operation button, emergency stop, and the like, between the control section 102 and the portable teaching operation section 103. FIG. 6 shows a detailed view of the portable teaching operation section 103. In the drawings, reference numeral 105 designates a housing essentially assuming the shape of the letter T; and 106 designates a hand section to be grasped by the operator. An operation surface of the housing 105 is provided with a keyboard (or a shift key) 107 to be operated during teaching operation; an LCD display 108 for displaying teach data, various pieces of information such as the position of a robot, and the like; and an emergency stop switch 109 (corresponding to emergency stop operation means). One end of the cable 104 is connected to the housing 105.

When the operator has depressed any of directional keys of the keyboard 107 assigned to respective axes of the robot, axial operation information is transmitted to the control section 102 by way of the cable 104; and the control section 102 outputs commands to unillustrated drive motors of the robot 101, thereby actuating the robot 101. The word “directional key” used herein is a key for use in instructing the direction of operation of the motors during teaching operation.

Likewise, when the operator depresses the emergency stop switch 109, emergency stop information is transmitted to the control section 102 by way of the cable 104, whereby the control section 102 shuts off power supply to the unillustrated drive motors of the robot 101, to thus apply unillustrated brakes to respective drive motors and thereby forcefully deactivate operation of the robot 101. Thereby, the robot can be stopped in emergency without fail in response to unintended accidental operation.

In the above-described related-art robot system, at the time of carriage of the portable teaching operation section 103, the operator must perform teaching operation while dragging the cable, which poses heavy burden on the operator and which also presents a problem of limitation being imposed on the degree of operation freedom achieved during teaching operation. Therefore, a strong desire exists for embodying the cable 104 between the control section 102 and the portable teaching operation section 103 by means of wireless communication. For instance, Patent Document 2 describes means for implementing an emergency stop function for a robot system—in which a portable teaching operation section equipped with emergency stop operation means which blocks power supply to drive motors for actuating a robot, to thus bring the robot into an emergency stop,—is configured so as to establish wireless communication with a control section for controlling the robot. Likewise, for instance, Patent Document 3 describes implementation means which, when a signal from a service emitter provided in a portable teaching operation section is lost, outputs to a control section a stop signal for stopping operation of the robot; and the control section determines occurrence of any anomaly when provided with an input of the stop signal, thereby deactivating operation of the robot, to thus avoid runaway of the robot.

### Patent Document 1: JP-A-2000-280193 (Pg. 7, FIGS. 1 and 2)

### Patent Document 2: JP-A-2004-148488

### Patent Document 3: JP-A-7-195285 (Pg. 3, FIG. 1)

### DISCLOSURE OF THE INVENTION

### Problems to be Solved by the Invention

However, in the system for connecting the controller with the portable teaching operation section by means of wireless communication as described in Patent Documents 2 and 3, when a communication failure has arisen in wireless communication during playback operation which does not require the portable teaching operation section at all times, it may be the case where operation of the robot will be stopped, thereby exerting great influence on a production process.

The present invention has been conceived in light of such a drawback and aims at providing an automatic machine system and a method for controlling communication thereof, wherein a portable wireless teaching operation section is equipped with means for disconnecting wireless communication as required at the time of playback operation, or the like, thereby preventing deactivation of a robot even when a communication failure has arisen in wireless communication.

### Means for Solving the Problems

The present invention is configured as follows in order to solve the problem.

According to claim 1 of the invention, there is provided

an automatic machine system including:

a mechanism section having one or more drive mechanisms,

a controller for driving and controlling the mechanism section, and

a portable teaching operation section for performing operation and teaching of the mechanism section, wherein

the controller includes;
a controller wireless communication section for establishing wireless communication with the portable teaching operation section; and
a drive section for driving the mechanism section in accordance with a command signal from the portable teaching operation section received by the controller wireless communication section, and

the portable teaching operation section includes;
a teaching operation section wireless communication section for establishing wireless communication with the controller;
a wireless changeover switch for selecting establishment or cancellation of wireless communication with the controller;
an emergency stop switch for shutting off and stopping a supply of drive energy to the drive section; and
a display device for displaying information to an operator.

According to claim 2 of the invention, there is provided

the automatic machine system, wherein

the portable teaching operation section selects a cancellation position by means of the wireless changeover switch to transmit a wireless communication cancellation request to the controller, and

upon receipt of the wireless communication cancellation request, the controller cancels established wireless communication with the portable teaching operation section and invalidates stoppage of the drive section effected by the emergency stop switch of the portable teaching operation section.

According to claim 3 of the invention, there is provided

the automatic machine system, wherein

the portable teaching operation section selects an establishment position by means of the wireless changeover switch to transmit a wireless communication establishment request to the controller, and

upon receipt of the wireless communication establishment request, the controller establishes wireless communication with the portable teaching operation section and validates stoppage of the drive section effected by the emergency stop switch of the portable teaching operation section.

According to claim 4 of the invention, there is provided

the automatic machine system, wherein

when the mechanism section plays back taught operation, the controller cancels established wireless communication with the portable teaching operation section and invalidates stoppage of the drive section effected by the emergency stop switch of the portable teaching operation section.

According to claim 5 of the invention, there is provided

the automatic machine system, wherein

the portable teaching operation section makes a setting for establishing wireless communication with the plurality of respective controllers when wireless communication is not yet established, and

an establishment position is selected by means of the wireless changeover switch after selection of a controller which is a target of connection to transmit a wireless communication establishment request to the selected controller.

According to claim 6 of the invention, there is provided

the automatic machine system, wherein

the wireless changeover switch is a touch switch provided on a display screen of the portable teaching operation section.

According to claim 7 of the invention, there is provided

the automatic machine system, wherein

in addition to being able to establish or cancel wireless communication with the controller, the wireless changeover switch is capable to select a monitor mode for acquiring status of the controller,

the portable teaching operation section transmits a monitoring request to the controller by means of selecting a monitor mode through use of the wireless changeover switch,

upon receipt of the monitoring request, the controller invalidates stoppage of the drive section effected by the emergency stop switch of the portable teaching operation section and transmits information about inside of the controller to the portable teaching operation section, and

the portable teaching operation section displays, on the display screen, the information about the inside of the controller.

According to claim 8 of the invention, there is provided

the automatic machine system, wherein

the mechanism section is a robot.

According to claim 9 of the invention, there is provided

a method for controlling a communication with an automatic machine system including a controller for driving and controlling a mechanism section having one or more drive mechanisms, and a portable teaching operation section for operating the mechanism section,

the method including the steps of:

establishing or canceling wireless communication between the portable teaching operation section and the controller by means of operating the wireless changeover switch of the portable teaching operation section,

when wireless communication is established, by the controller, validating a function for shutting off and stopping a supply of drive energy to the mechanism section by means of an emergency stop switch of the portable teaching operation section, and

when established wireless communication is canceled, by the controller, invaliding the function for shutting off and stopping the supply of drive energy to the mechanism section by means of the emergency stop switch of the portable teaching operation section.

### EFFECTS OF THE INVENTION

According to the inventions defined in claims 1 and 2, when taught operation is played back, the operator cancels established wireless communication between the portable teaching operation section and the controller by means of the wireless changeover switch of the portable teaching operation section, to thus invalidate the function for bringing the mechanism section to an emergency stop by means of operation of the emergency stop switch of the portable teaching operation section. As a result, there even when a failure has arisen in wireless communication during playback operation, operation of the mechanism section is not stopped, which yields an advantage of a production process being not affected.

Moreover, according to the invention defined in claim 3, during a period of time other than playback operation, wireless communication is established between the portable teaching operation section and the controller by means of the wireless changeover switch of the portable teaching operation section, to thus validate the function for bringing the mechanism section to an emergency stop by means of operation of the emergency stop switch of the portable teaching operation section. As a result, the operator can stop operation of the mechanism section by operation of the emergency stop switch of the portable teaching operation section. Further, there is yielded an advantage of the capability of safely stopping operation of the mechanism section even when the failure has arisen in wireless communication.

According to the invention defined in claim 4, when taught operation is played back, established wireless communication between the portable teaching operation section and the controller is automatically canceled, to thus invalidate the function for bringing the mechanism section to the emergency stop by means of operation of the emergency stop switch of the portable teaching operation section. As a result, there is yielded an advantage of, even when the operator forgets to operate the wireless changeover switch, the mechanism section being not stopped by a failure occurred in wireless communication during playback operation.

According to the invention defined in claim 5, after settings of wireless communication with the plurality of respective controllers are made by way of the portable teaching operation section, a controller which is a target of connection is selected, and wireless connection is established with the controller by means of the wireless changeover switch. As a result, the plurality of controllers can be operated, while being switched one from another, by means of one portable teaching operation section, and settings pertaining to controllers which are targets of connection can be registered in advance, as well. There is also yielded an advantage of the capability of preventing establishment of wireless communication with an unintended controller by means of erroneous operation of the operator by carrying out steps of selection and switching operation.

According to the invention defined in claim 6, the wireless changeover switch is embodied as touch switch provided on the display screen of the portable teaching operation section. As a result, a case where a space for a key layout is not available on the portable teaching operation section can also be addressed, and the portable teaching operation section can be miniaturized.

According to the invention defined in claim 7, the monitoring request is transmitted from the portable teaching operation section to the controller by means of operation of the wireless changeover switch, thereby invalidating the function for bringing the mechanism section to the emergency stop by means of operation of the emergency stop switch of the portable teaching operation section. Information about the inside of the controller is transmitted to the portable teaching operation section and presented on the display screen. As a result, even when the failure arises in wireless communication during playback operation, operation of the mechanism section is not stopped. Further, there is yielded an advantage of the operator being able to monitor the status of the controller by means of the portable teaching operation section at hand.

According to the invention defined in claim 8, there is yielded an advantage of, even when the failure arises in wireless communication during playback operation of the robot, operation of the robot being not stopped and a production processing being not affected.

According to the invention defined in claim 9, during playback operation, established wireless communication between the portable teaching operation section and the controller is canceled by means of the wireless changeover switch of the portable teaching operation section, to thus invalidate the function for bringing the mechanism section to the emergency stop by means of operation of the emergency stop switch of the portable teaching operation section. As a result, there is yielded an advantage of, even when the failure arises in wireless communication during playback operation, operation of the mechanism section being not stopped and a production processing being not affected.

### BRIEF DESCRIPTION OF THE DRAWINGS

FIG. 1 is a block diagram of a robot system of a first embodiment of the present invention.

FIG. 2 is a detailed view of a portable teaching operation section of the first embodiment of the present invention.

FIG. 3 is a detailed view of the robot system of the first embodiment of the present invention.

FIG. 4 is a detailed view of a portable teaching operation section of a third embodiment of the present invention.

FIG. 5 is a block diagram of a related-art robot system.

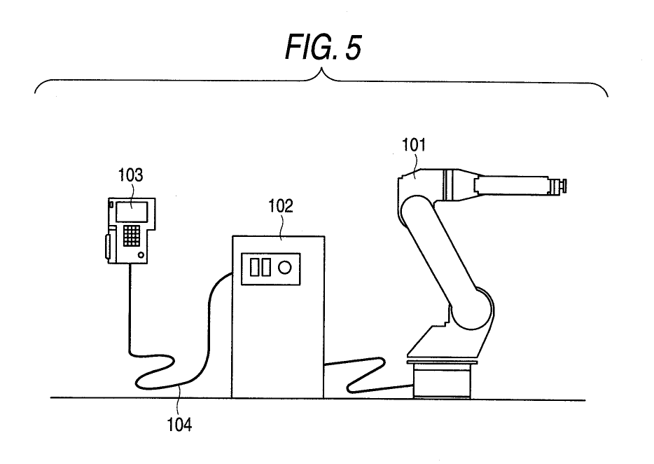

FIG. 6 is a detailed view of a related-art portable teaching operation section.

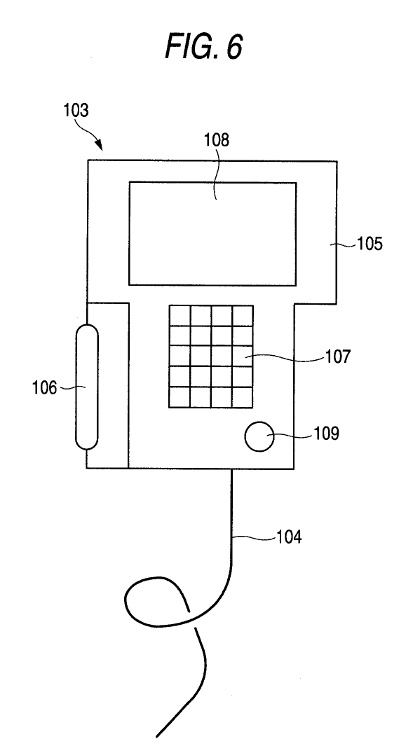

### DESCRIPTION OF THE REFERENCE NUMERALS

1 Robot

2 Controller

3 Portable Teaching Operation Section

4 Wireless Communication

5 Housing

6 Hand Section

7 Keyboard

8 LCD Display

9 Emergency Stop Switch

10 Antenna

11 Battery

12 Power Switch

13 Wireless Changeover Switch

14 Operation Mode Changeover Switch

15 Wireless Communication Establishment Touch Switch

16 Setting Touch Switch

21 Control Section

22 Servo Amplifier(s)

23 Drive Motor(s)

24 Antenna

25 LCD Display

26 Operation Mode Changeover Switch

101 Robot

102 Control Section

103 Portable Teaching Operation Section

104 Cable

105 Housing

106 Hand Section

107 Keyboard

108 LCD Display

109 Emergency Stop Switch

### BEST MODES FOR CARRYING OUT THE INVENTION

Specific embodiments of a method of the present invention will be described hereunder by reference to the drawings.

### First Embodiment

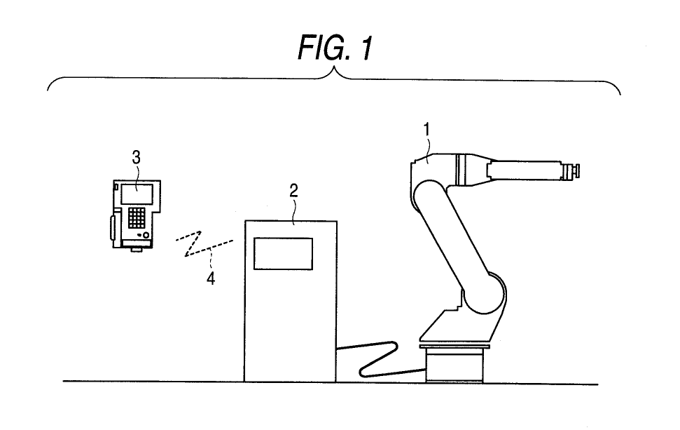

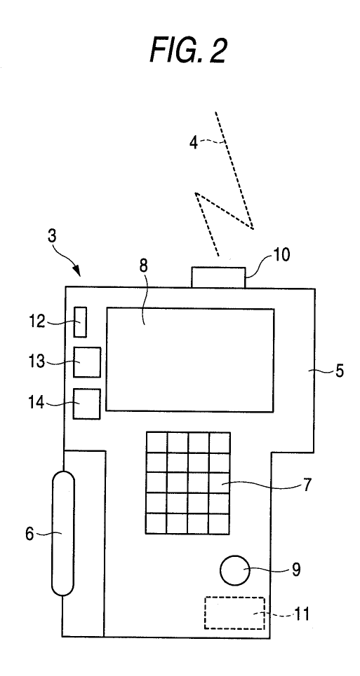

FIG. 1 is a block diagram of an automatic machine (assumed to be a robot herein) of a first embodiment of the present invention. In the drawing, reference numeral 1 designates a robot; 2 designates a controller for controlling operation of the robot 1; 3 designates a portable teaching operation section; and 4 designates wireless communication (reference symbol 4 is diagrammatically depicted) for transmitting information about an operation button, emergency stop, or the like, exchanged between the controller 2 and the portable teaching operation section 3. FIG. 2 shows a detailed view of the portable teaching operation section 3. In the drawing, reference symbol 5 designates a housing essentially assuming the shape of the letter T; and 6 designates a hand section grasped by an operator. An operation surface of the housing 5 is provided a keyboard (or a key sheet) 7 operated by the operator during teaching operation; an LCD display 8 for displaying various pieces of information, such as teaching data, the position of the robot, and the like; and an emergency stop switch 9 (corresponding to emergency stop operation means). The LCD display may also be another display means, such as an organic EL display.

The housing 5 is also equipped with an antenna 10 serving as transceiving means for wireless communication 4, a battery 11 for supplying power independently of the controller 2, and a power switch 12 for commencing/stopping power supply.

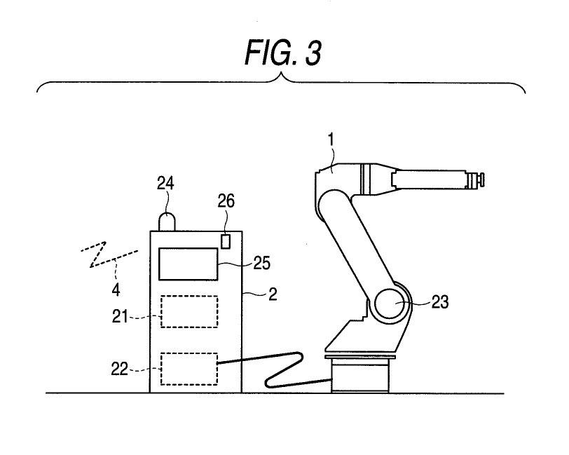

FIG. 3 shows a detailed view of the controller 2. In the drawing, reference numeral 21 designates a control section for computing a current command for drive motors; 22 designates servo amplifiers for driving the drive motors in accordance with the current command; 23 designates the drive motors attached to the robot 1; 24 designates an antenna serving as transceiving means for wireless communication 4; and 25 designates an LCD display for displaying an operating status of the robot, an alarm, or the like. As in the case of the portable teaching operation section, the LCD display may also be another display means, such as an organic EL display.

As a result of the operator pressing a guide operation button for each axis of the robot 1 assigned to the keyboard 7 of the portable teaching operation section 3, axis operation information is transmitted to the control section 21 of the controller 2 by means of wireless communication 4. The control section 21 activates the robot 1 by supplying power to the drive motors 23 of the robot 1.

When the operator depresses the emergency stop button 9, emergency stop information is transmitted to the controller 2 by means of wireless communication 4, and the control section 21 forcefully deactivates operation of the robot 1 by means of shutting off power supply to the drive motors 23 of the robot 1. By means of the emergency stop function, the robot 1 is stopped without fail in response to unintentional, accidental operation.

In the robot system, such as that shown in FIG. 1, the operator first performs teaching operation which forms a round of operations by repetition of operation for causing the robot 1 to move to an appropriate position and storing the position, by use of operation buttons provided on the portable teaching operation section 3. When teaching operation is completed, the round of operations instructed to the robot 1 are continuously performed through playback in accordance with a command from the portable teaching operation section 3 or the controller 2, thereby performing desired operation.

In the present invention, the portable teaching operation section 3 is newly provided with a wireless changeover switch 13. The wireless changeover switch 13 can select whether to establish or shut off wireless communication between the portable teaching operation section 3 and the controller 2.

At the time of teaching operation, the operator switches the wireless changeover switch 13 to an establishment position, whereupon a wireless communication establishment request is transmitted from the portable teaching operation section 3 to the controller 2, and the controller 2 establishes wireless communication with the portable teaching operation section 3. As a result of establishment of wireless communication, the controller 2 validates control of energization of the servo amplifiers 22 performed by the emergency stop switch 9 in accordance with the portable teaching operation section 3.

Control of energization of the servo amplifiers 22 performed by the emergency stop switch 9 means that the servo amplifiers 22 are energized in a (OFF) state where the emergency stop switch 9 is not pressed and that energization of the servo amplifiers 22 are shut off in a (ON) state where the emergency stop switch 9 is pressed. When energization of the servo amplifiers 22 are shut off, power supply to the drive motors 23 are also shut off, whereupon the robot 1 is deactivated.

As a result of validation of the function, the operator can safely activate the drive motors 23 of the robot 1, thereby performing operation for teaching the robot 1.

For example, when the operator has come close to contacting the robot 1 during teaching operation, the operator depresses the emergency stop switch 9, whereupon information about operation of the emergency stop switch is transmitted from the portable teaching operation section 3 to the controller 2 by means of wireless communication 4; and the controller 2 shuts off energization of the servo amplifiers 22 connected to the drive motors 23. Since drive power supply to the drive motors 23 is also shutoff, the robot 1 can be safely stopped immediately.

When the robot 1 is caused to perform the instructed operation through playback after completion of teaching operation, the operator switches the wireless changeover switch 13 to a cancellation position, whereupon the portable teaching operation section 3 transmits a wireless communication cancellation request to the controller 2, and the controller 2 cancels establishment of wireless communication. Thereby, the controller 2 invalidates control of energization of the servo amplifiers 22 performed by the emergency stop switch 9 in accordance with the portable teaching operation section 3.

Invalidation of control of energization of the servo amplifiers 22 performed by the emergency stop switch 9 means continuation of energized state of the servo amplifiers 22 regardless of operation of the emergency stop switch.

As a result, the robot 1 can perform playback operation without being stopped even when the emergency stop switch 9 is pressed.

As mentioned previously, when a failure has arisen in wireless communication between the portable teaching instruction section 3 and the controller 2 in the related art, the robot 1 is stopped for safety. However, control of energization of the servo amplifiers 22 performed by the emergency stop switch 9 of the portable teaching operation section 3 is also invalidated when the controller 2 cancels establishment of wireless communication with the portable teaching operation section 3. Accordingly, the robot 1 can be activated by means of only the controller 2 regardless of status of a radio wave used for wireless communication.

According to the present system, as a result of the operator operating the wireless changeover switch 13 provided on the portable teaching operation section 3, the robot 1 can be arbitrarily stopped during teaching operation in accordance with emergency stop switch information sent from the portable teaching operation section 3 through wireless communication. During playback operation, playback operation of the robot 1 can be continued regardless of emergency stop switch information sent from the portable teaching operation section 3 through wireless communication or an ambient wireless communication environment.

### Second Embodiment

In order to enhance operability of the operator, the chance of the operator forgetting to switch between establishment and cancellation of wireless communication must be obviated. In general, an operation mode changeover switch 14 for switching between a teaching operation mode and a playback operation mode is provided on the portable teaching operation section 3 or the controller 2. A second embodiment of the present invention is to cause the operation mode changeover switch 14 to substitute as the wireless changeover switch 13.

As a result of the operator switching the operation mode changeover switch 14 to the teaching operation mode, processing analogous to that performed when the wireless changeover switch 13 is switched to the establishment position is performed. Likewise, as a result of the operation mode changeover switch 14 being switched to the playback operation mode, processing analogous to that performed when the wireless changeover switch 13 is switched to the cancellation position is performed.

Flow of actual processing is as follows. When the operation mode changeover switch 14 is provided on the portable teaching operation section 3, the portable teaching operation section 3 transmits a wireless communication establishment request to the controller 2 by means of switching the operation mode changeover switch 14 to the teaching operation mode, and the controller 2 establishes wireless communication. Concurrently, control of energization of the servo amplifier 22 performed by the emergency stop switch 9 of the portable teaching operation section 3 is validated, whereby switching to the teaching operation mode is performed.

Likewise, the operation mode changeover switch 14 is switched to the playback operation mode, whereupon the portable teaching operation section 3 transmits a wireless communication establishment cancelation request to the controller 2, and the controller 2 cancels establishment of wireless communication. Concurrently, control of energization of the servo amplifier 22 performed by the emergency stop switch 9 of the portable teaching operation section 3 is invalidated, whereupon switching to the playback operation mode is performed.

When the operation mode changeover switch 26 is provided on the controller 2, the controller 2 transmits the wireless communication establishment request to the portable teaching operation section 3 by means of switching the operation mode changeover switch 26 to the teaching operation mode, and the controller 2 establishes wireless communication. Concurrently, control of energization of the servo amplifier 22 performed by the emergency stop switch 9 of the portable teaching operation section 3 is validated.

Likewise, the controller 2 transmits the wireless communication establishment cancellation request to the portable teaching operation section 3 by means of switching the operation mode changeover switch 26 to the playback operation mode, and the controller 2 cancels establishment of wireless communication. Concurrently, control of energization of the servo amplifiers 22 performed by the emergency stop switch 9 of the portable teaching operation section 3 is invalidated.

Even when the operation mode of the controller 2 is switched through remote operation performed by an unillustrated high-level system, there may also be adopted a configuration for automatically establishing/canceling wireless communication in accordance with a change in the operation mode of the controller 2.

According to the present system, establishment and cancellation of wireless communication can be automatically switched by means of operation of the operation mode changeover switch without the operator especially being aware of wireless communication.

### Third Embodiment

When a plurality of controllers which are to serve as targets of wireless communication are provided for one portable teaching operation section 3, it is necessary to specify a desired target without involvement of complicated procedures in order to prevent danger. A third embodiment of the present invention takes the necessity into account.

In relation to wireless communication 4 with a plurality of controllers which are targets of wireless communication, a communication method and settings (IP addresses and channel numbers of controllers which are objects of connection when; for example, a wireless LAN, is utilized) are individually set in advance by means of the portable teaching operation section 3.

When teaching operation, or the like, must be performed by use of the robot 1 connected to a specific controller 2, the operator ascertains, by means of a screen on the LCD display 8 on the portable teaching operation section 3, whether or not wireless communication 4 is established between the portable teaching operation section 3 and the plurality of controllers serving as targets of wireless communication.

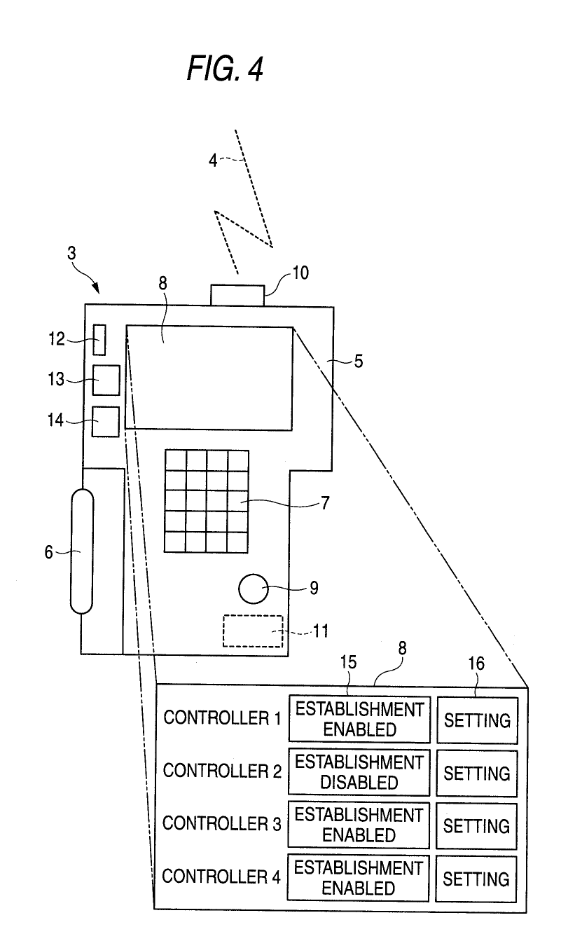

FIG. 4 is an example of the enabled status/disabled status of wireless communication of each of the plurality of controllers serving as targets of wireless communication being displayed on the LCD display 8. In the drawing, reference numerals 15 and 16 are touch switches appearing on the LCD display 8 having a touch screen function. Advantages analogous to those which will be yielded when an actual switch is pressed are provided by touching switch fields on the LCD display 8.

The operator selects a specific controller by pressing the touch switch 15 on a list of controllers with which wireless communication can be established, and switches the wireless changeover switch 13 on the portable teaching operation section 3 to the establishment position, thereby establishing wireless communication with the specific controller.

When wireless communication is promptly established by means of pressing only the touch switch 15, there is a potential risk of wireless communication being established with another unintended controller by means of erroneous operation of the operator. For this reason, there is adopted two-step operation including operation for selecting the touch switch 15 and subsequent operation for actually establishing wireless communication by pressing wireless the changeover switch 13. Alternatively, processing for switching the wireless changeover switch 13 may also be omitted by addition of processing for displaying, when the touch switch 15 is pressed, on the LCD display 8 a touch switch for confirmation along with a message inquiring of the operator “whether to really establish wireless communication.”

Moreover, in addition to enabling selection of the specific controller 2, the configuration may also enable immediate invoking a screen for setting a connection with the controller and modification by means of the touch switch 16.

As a result the wireless changeover switch 13 being embodied as a touch switch displayed on the LCD display 8, a case where no space for a key layout is available on the portable teaching operation section 3 can also be addressed.

When the space for the key layout is available, a plurality of controllers serving as targets of wireless communication may also be previously assigned in a selectable manner, as means for selecting the specific controller 2, to switches which are equal in number to the controllers rather than to the touch switches.

According to the present system, when a plurality of controllers serving as targets are available for one portable teaching operation section 3, the operator can easily select a target of communication without conducting complicated procedures or readily change a communications setting for each controller.

Moreover, since a connectable controller can be displayed in the form of a list and selected, intuitive operation of the operator is enabled.

### Fourth Embodiment

There may be a case where the operator needs to monitor internal information about the controller 2 during playback operation or operating status of the robot 1. The fourth embodiment of the present invention takes it into account.

In the present embodiment, in addition to being provided with the function of establishing/canceling wireless communication, the wireless changeover switch 13 of the portable teaching operation section 3 is provided with a function of enabling selection of another monitor mode.

When the operator switches the wireless changeover switch 13 of the portable teaching operation section 3 to a monitor mode, a monitoring request is transmitted from the portable teaching operation section 3 to the controller 2. As a result, the controller 2 invalidates control of energization of the servo amplifiers 22 performed by the emergency stop switch 9 of the portable teaching operation section 3 while maintaining establishment of wireless communication with the portable teaching operation section 3.

As a result, the drive motors 23 of the robot 1 can be driven regardless of operation of the emergency stop switch of the portable teaching operation section 3, so that the robot 1 can perform playback operation.

A difference between the first embodiment and the fourth embodiment lies in that wireless communication established between the controller 2 and the portable teaching operation section 3 is not canceled even at the time of playback operation. As a result, the operator can ascertain internal information about the controller 2 or operating status of the robot 1 transmitted to the portable teaching operation section 3 through wireless communication 4.

As mentioned previously, when a failure has arisen in wireless communication between the portable teaching operation section 3 and the controller 2 in the related art, the robot 1 is stopped for safety. However, in the present embodiment, only the function for controlling energization of the servo amplifiers 22 performed by the emergency stop switch 9 is invalidated, whereby the robot 1 can be activated by means of only the controller 2 regardless of the state of a radio wave of wireless communication.

According to the present system, by means of the operator operating the wireless changeover switch 13 on the portable teaching operation section 3, the robot 1 can be arbitrarily stopped during teaching operation in accordance with information about the emergency stop switch transmitted from the portable teaching operation section 3 through wireless communication. During playback operation, the robot can continually perform playback operation regardless of the information about the emergency stop switch transmitted from the portable teaching operation section 3 through wireless communication or an ambient wireless communication environment. Moreover, a function for monitoring the internal information about the controller 2 and the operating status of the robot during playback operation is added.

### INDUSTRIAL APPLICABILITY

The present invention can be widely applied to a wireless portable teaching operation section of an industrial robot intended for welding, painting, assembly, or the like. Provision of a switch for canceling wireless communication at the time of playback operation enables continual operation of the robot even when a failure has arisen in wireless communication during playback operation.

1. An automatic machine system comprising:
a mechanism section having one or more drive mechanisms,
a controller for driving and controlling the mechanism section, and
a portable teaching operation section for performing operation and teaching of the mechanism section, wherein
the controller includes;
a controller wireless communication section for establishing wireless communication with the portable teaching operation section; and
a drive section for driving the mechanism section in accordance with a command signal from the portable teaching operation section received by the controller wireless communication section, and
the portable teaching operation section includes;
a teaching operation section wireless communication section for establishing wireless communication with the controller;
a wireless changeover switch for selecting establishment or cancellation of wireless communication with the controller;
an emergency stop switch for shutting off and stopping a supply of drive energy to the drive section; and
a display device for displaying information to an operator.

2. The automatic machine system according to claim 1, wherein
the portable teaching operation section selects a cancellation position by means of the wireless changeover switch to transmit a wireless communication cancellation request to the controller, and
upon receipt of the wireless communication cancellation request, the controller cancels established wireless communication with the portable teaching operation section and invalidates stoppage of the drive section effected by the emergency stop switch of the portable teaching operation section.

3. The automatic machine system according to claim 1, wherein
the portable teaching operation section selects an establishment position by means of the wireless changeover switch to transmit a wireless communication establishment request to the controller, and
upon receipt of the wireless communication establishment request, the controller establishes wireless communication with the portable teaching operation section and validates stoppage of the drive section effected by the emergency stop switch of the portable teaching operation section.

4. The automatic machine system according to claim 1, wherein when the mechanism section plays back taught operation, the controller cancels established wireless communication with the portable teaching operation section and invalidates stoppage of the drive section effected by the emergency stop switch of the portable teaching operation section.

5. The automatic machine system according to claim 1, wherein
the portable teaching operation section makes a setting for establishing wireless communication with the plurality of respective controllers when wireless communication is not yet established, and
an establishment position is selected by means of the wireless changeover switch after selection of a controller which is a target of connection to transmit a wireless communication establishment request to the selected controller.

6. The automatic machine system according to claim 1, wherein
the wireless changeover switch is a touch switch provided on a display screen of the portable teaching operation section.

7. The automatic machine system according to claim 1, wherein
in addition to being able to establish or cancel wireless communication with the controller, the wireless changeover switch is capable to select a monitor mode for acquiring status of the controller,
the portable teaching operation section transmits a monitoring request to the controller by means of selecting a monitor mode through use of the wireless changeover switch,
upon receipt of the monitoring request, the controller invalidates stoppage of the drive section effected by the emergency stop switch of the portable teaching operation section and transmits information about inside of the controller to
the portable teaching operating section, and the portable teaching operation section displays, on the display screen, the information about the inside of the controller.

8. The automatic machine system according to claim 1, wherein the mechanism section is a robot.

9. A method for controlling communication with an automatic machine system including a controller for driving and controlling a mechanism section having one or more drive mechanisms, and a portable teaching operation section for operating the mechanism section,
the method comprising the steps of:
establishing or canceling wireless communication between the portable teaching operation section and the controller by means of operating the wireless changeover switch of the portable teaching operation section,
when wireless communication is established, by the controller, validating a function for shutting off and stopping a supply of drive energy to the mechanism section by means of an emergency stop switch of the portable teaching operation section, and
when established wireless communication is canceled, by the controller, invaliding the function for shutting off and stopping the supply of drive energy to the mechanism section by means of the emergency stop switch of the portable teaching operation section.
